(19) United States
(12) Patent Application Publication
(10) Pub. No.: US 2015/0142259 A1
(43) Pub. Date: May 21, 2015

(54) WHEEL POSITION DETECTING DEVICE AND TIRE AIR PRESSURE DETECTING APPARATUS INCLUDING THE SAME

(71) Applicant: DENSO CORPORATION, Kariya-city, Aichi-pref. (JP)

(72) Inventors: Masashi Mori, Obu-city (JP); Nobuya Watabe, Nagoya-city (JP)

(21) Appl. No.: 14/406,442

(22) PCT Filed: Jun. 6, 2013
(86) PCT No.: PCT/JP2013/003544

§ 371 Date: Dec. 8, 2014

(30) Foreign Application Priority Data
Jun. 11, 2012 (JP) 2012-132054

(51) Int. Cl. B60C 23/04

(52) U.S. Cl. CPC B60C 23/0416; B60C 23/0488; B60C 23/0455; B60C 23/0489
USPC 701/32.7

(57) ABSTRACT

In a wheel position detecting device, a first controlling section of a transmitter transmits a frame when an increasing or decreasing direction of values of gravitational acceleration components included in detection signals of an acceleration sensor, which is detected at predetermined intervals, is continuously the same direction. A second controlling section of a receiver acquires gear information indicating a teeth position of gears in accordance with the detection signal of wheel speed sensors, and performs the wheel position detection in accordance with gear information at a reception timing of the frame.

### CROSS REFERENCE TO RELATED APPLICATION

The present disclosure is based on Japanese Patent Application No. 2012-132054 filed on Jun. 11, 2012, the disclosure of which is incorporated herein by reference.

### TECHNICAL FIELD

The present disclosure relates to a wheel position detecting device that detects in which position of a vehicle a wheel to be detected is mounted, and a tire air pressure detecting apparatus including the wheel position detecting device.

### BACKGROUND ART

Conventionally, there has been a direct-type tire air pressure detecting apparatus. In this type of the tire air pressure detecting apparatus, transmitters provided with sensors such as a pressure sensor are directly attached to wheels to which tires are attached. In addition, an antenna and a receiver are provided to a vehicle body. When a detection signal from the sensor is transmitted from the transmitter, the detection signal is received by the receiver through the antenna, and thus the tire air pressure is detected.

In such a direct-type tire air pressure detecting apparatus, it has to be determined whether the transmitted data is for the subject vehicle, and to which wheel the transmitter that transmits the data is attached. In order to realize these, pieces of ID information, for determining whether the data is for the subject vehicle or for another vehicle and for determining the wheel to which the transmitter is attached, are given to the data that the corresponding transmitters transmit.

In order to specify a position of the transmitter from the ID information included in the transmission data, the ID information of the transmitters needs to be registered in advance in the receivers-side in association with the positions of the corresponding wheels. Therefore, at the time of tire rotation, relationships between the ID information of the transmitters and the positions of the wheels need to be reregistered to the receivers. As a technology that allows this registering to be automatically carried out, methods described in Patent Literatures 1, 2 have been proposed.

Specifically, an apparatus described in Patent Literature 1, an acceleration detecting signal of an acceleration sensor provided in a transmitter on the wheel-side is monitored, thereby to detect that a wheel has been set at a predetermined rotational position, namely, an angle of the transmitter has been a specific angle during one rotation of a tire. In addition, the rotational position of the wheel at the time of receiving a radio signal from the transmitter is detected even on the vehicle body-side, thereby to specify the wheel position by monitoring changes of a relative angle of these. In this method, a change of the relative angle of the rotational positions of the wheels detected on the wheel-side and on the vehicle body-side is monitored based on deviations of the predetermined number of data. By determining that the variations exceed an acceptable value in relation to an initial value, the wheel position is specified.

In addition, in the apparatus described in Patent Literature 2, when the transmitter on the wheel-side carries out data transmission, a tire rotational cycle is measured by an acceleration sensor. When the transmitter becomes a specific angle during one rotation of the tire, the data transmission is carried out.

### PRIOR ART LITERATURES

### Patent Literature

Patent Literature 1: JP 2010 122023 A
Patent Literature 2: U.S. Pat. No. 6,112,587

### SUMMARY OF INVENTION

### Technical Problem

However, in the apparatuses described in Patent Literatures 1, 2, an oscillation amplitude of the detection signal of the acceleration sensor needs to be detected in order to detect that the angle of the transmitter becomes the specific angle, which makes it necessary for the acceleration sensor to be kept on for a plurality of rotations of the tire. Therefore, power consumption is increased, which causes an influence on a battery life.

In view of the above, an object of the present disclosure is to provide a wheel position detecting device that is capable of further suppressing consumption power, and a tire air pressure detecting apparatus including the wheel position detecting device.

### Solution to Problem

A wheel position detecting device according to one aspect of the present disclosure is applied to a vehicle in which a plurality of wheels provided with tires are attached to a vehicle body and includes a transmitter and a receiver. The transmitters are provided in a corresponding one of the plurality of the wheels, and has a first controlling section that produces and transmits a frame including specific identification information. The receiver is provided in the vehicle body and has a second controlling section. The second controlling section receives the frame transmitted from the transmitters through a reception antenna to specify in which wheel the transmitters that have transmitted the frame are provided, and carries out wheel position detection by which the plurality of the wheels and the identification information of the transmitters provided in the plurality of the wheels are stored in association with each other.

Each of the transmitters includes an acceleration sensor that measures acceleration including a gravitational acceleration component that varies in connection with rotation of the wheels in which the corresponding transmitters are provided at predetermined intervals, and outputs a detection signal depending on the acceleration.

The first controlling section detects transmission timing in accordance with a value of the gravitational acceleration component included in the detection signal of the acceleration sensor, which is detected at predetermined intervals, and repeatedly transmits the frame when an establishing condition is met. The establishing condition of the transmission timing is that an increasing or decreasing direction of values of the gravitational acceleration components are continuously the same direction.

The second controlling section acquires gear information indicating a tooth position of gears in accordance with a detection signal of wheel speed sensors that outputs the detection signal depending on transits of teeth of the gears that are rotated in connection with the plurality of the wheels, and specifies the wheels in which the transmitters that have transmitted the frame are provided, in accordance with whether the teeth position is included in a range of 180 degrees of the gears at the reception timing of the frame.

According to the wheel position detecting device, power consumption can be suppressed because the acceleration detection by the acceleration sensor is not needed to constantly carry out.

A tire air pressure detecting apparatus according to another aspect of the present disclosure includes the wheel position detecting device. The transmitter includes a sensing section that outputs a detection signal depending on an air pressure of the tire provided to each of the plurality of the wheels, and transmits a frame to the receiver after storing information regarding the air pressure of the tire for which the detection signal of the sensing section is signal-processed by the first controlling section in the frame. The receiver detects the air pressure of the tire provided to the plurality of the wheels from the information regarding the air pressure of the tire in the second controlling section.

### BRIEF DESCRIPTION OF DRAWINGS

The above and other objects, features and advantages of the present disclosure will become more apparent from the following detailed description made with reference to the accompanying drawings. In the drawings:

FIG. 1 is a view illustrating an entire configuration of a tire air pressure detecting apparatus to which a wheel position detecting device according to a first embodiment of the present disclosure is applied;

FIG. 2A is a block diagram illustrating a configuration of a transmitter;

FIG. 2B is a block diagram illustrating a configuration of a TPMS-ECU;

FIG. 3A is a view illustrating a relationship between a tire rotational angle and a value of a gravitational acceleration component;

FIG. 3B is a view illustrating a relationship between a tire rotational direction and a value of a frame transmission angle range;

FIG. 4A is a view illustrating a value of acceleration at a measurement point for every sampling cycle, and a method of determining whether frame transmission is possible or not, in accordance with the same;

FIG. 4B is a view illustrating a value of acceleration at a measurement point for every sampling cycle, and a method of determining whether frame transmission is possible or not, in accordance with the same;

FIG. 5 is a flowchart illustrating a data transmission process carried out by the transmitter;

FIG. 6 is a timing chart for explaining wheel position detection;

FIG. 7 is a view illustrating changes of gear information;

FIG. 8A is a view for explaining a wheel position confirming logic;

FIG. 8B is a view for explaining a wheel position confirming logic;

FIG. 8C is a view for explaining a wheel position confirming logic;

FIG. 9A is a view illustrating an evaluation result of a wheel position in a frame including ID1 as identification information;

FIG. 9B is a view illustrating an evaluation result of a wheel position in a frame including ID2 as identification information;

FIG. 9C is a view illustrating an evaluation result of a wheel position in a frame including ID3 as identification information;

FIG. 9D is a view illustrating an evaluation result of a wheel position in a frame including ID4 as identification information;

FIG. 10 is a graph illustrating a relationship between a vehicle speed and a time required for a wheel to rotate one rotation;

FIG. 11 is a flowchart illustrating a data transmission process carried out by the transmitter;

FIG. 12 is a graph illustrating a relationship between a vehicle speed and a time required for a wheel to rotate one rotation and measurement intervals;

FIG. 13A is a view illustrating a relationship between a tire rotational direction when the vehicle moves forward and the frame transmission angle range;

FIG. 13B is a view illustrating a relationship between the tire rotational direction when the vehicle moves forward and a value of the gravitational acceleration;

FIG. 13C is a view illustrating a relationship between a tire rotational direction when the vehicle moves backward and the frame transmission angle range; and

FIG. 13D is a view illustrating a relationship between the tire rotational direction when the vehicle moves backward and a value of the gravitational acceleration.

### EMBODIMENTS FOR CARRYING OUT INVENTION

In the following, embodiments of the present disclosure will be explained based on the drawings. Incidentally, the explanation is made with the same or equivalent reference symbols given to the same or equivalent portions throughout the following embodiments.

### First Embodiment

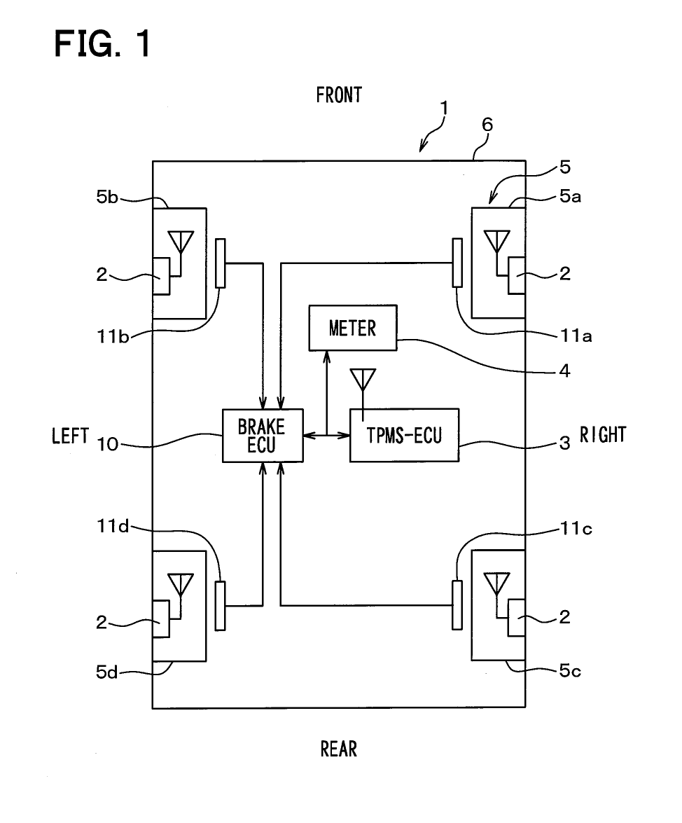

A first embodiment of the present disclosure is explained with reference to the drawings. First, an entire configuration of a tire air pressure detecting apparatus to which a wheel position detecting device according to a first embodiment of the present disclosure is applied is explained. Incidentally, an upward direction in the paper of FIG. 1 corresponds to a front side of a vehicle 1, and a downward direction corresponds to a rear side of the vehicle 1.

As illustrated in FIG. 1, the tire air pressure detecting apparatus, which is attached in the vehicle 1, is configured to have transmitters 2, an ECU 3 for the tire air pressure detecting apparatus (referred to as TPMS-ECU, hereinafter) that plays a role as a receiver, and a meter 4. The wheel position detecting device specifies a wheel position by using the transmitters 2 and the TPMS-ECU 3, which are provided in the tire air pressure detecting apparatus, and acquiring gear information obtained from detection signals of wheel speed sensors 11a-11d provided in corresponding wheels 5 (5a-5d).

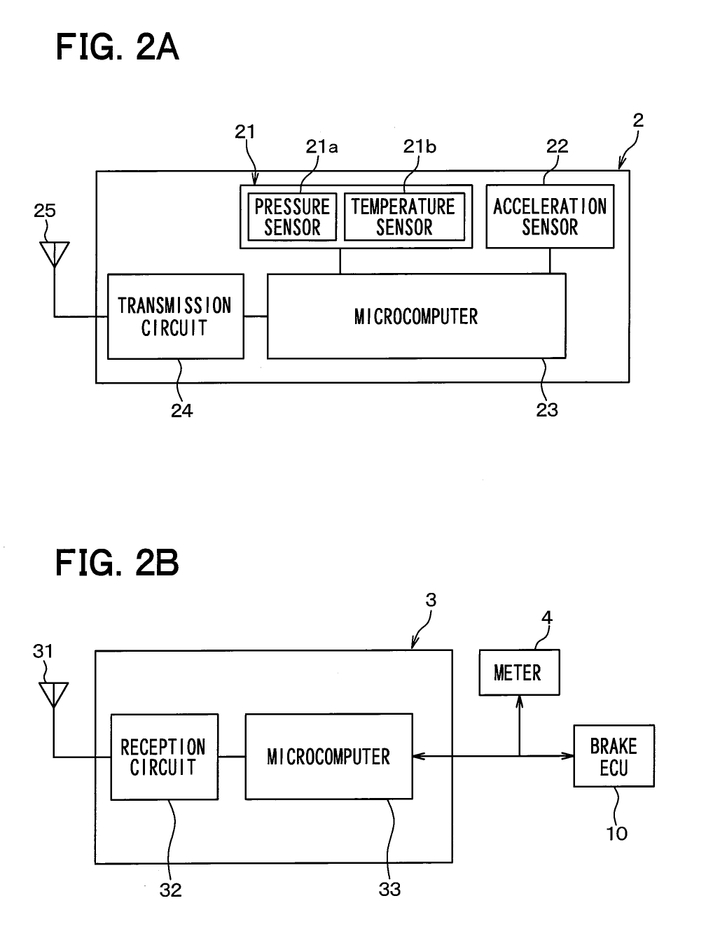

As illustrated in FIG. 1, the transmitters 2, which are attached to the corresponding wheels 5a-5d, detect air pressures of tires attached to the corresponding wheels 5a-5d, store information regarding the tire air pressures that indicate the detection results into a frame, and transmit the frame. The TPMS-ECU 3, which is attached on the side of a vehicle body 6 in a vehicle 1, receives the frame transmitted from the transmitters 2 and carries out various processes, calculations, or the like in accordance with the detection signal stored in the frame, thereby to carry out the wheel position detection and the tire air pressure monitoring. The transmitters 2 produce the frame in accordance with, for example, frequency-shift keying (FSK), and the TPMS-ECU 3 reads the data within the frame by demodulating the frame, thereby to carry out the wheel position detection and the tire air pressure monitoring. Detailed configurations of the transmitters 2 and the TPMS-ECU 3 are explained with reference to FIG. 2A and FIG. 2B, respectively.

As illustrated in FIG. 2A, the transmitter 2 is configured to have a sensing section 21, an acceleration sensor 22, a microcomputer 23, a transmission circuit 24, and a transmission antenna 25. Each section operates on electric power from an unillustrated battery.

The sensing section 21, which is configured to have a diaphragm-type pressure sensor 21a and a temperature sensor 21b, outputs a detection signal depending on the tire air pressure and a detection signal depending on a temperature. The acceleration sensor 22 is used to carry out the positional detection of the sensor its own in the corresponding wheels 5a-5d to which the transmitters 2 are attached, namely, a vehicle speed detection and the position detection for the transmitter 2. For example, the acceleration sensor 22 of the present embodiment outputs the detection signal depending on acceleration in a radius direction of each of the wheels 5a-5d, namely, acceleration in both directions perpendicular to the circumferential direction, among acceleration applied to the wheels 5a-5d when the wheels 5a-5d are rotating.

The microcomputer 23, which is a known one that is provided with a controlling section (a first controlling section), carries out predetermined processes in accordance with programs stored in a memory within the controlling section. The memory within the controlling section stores individual ID information including identification information, which is specific to and specifies the subject vehicle, and identification information, which is specific to and specifies the corresponding transmitters 2.

The microcomputer 23 receives the detection signal regarding the tire air pressure from the sensing section 21, and carries out signal processing on the detection signal and processes when necessary. The microcomputer 23 stores the information regarding the tire air pressure and the ID information of each of the transmitters 2 in the frame. In addition, the microcomputer 23 monitors the detection signal of the acceleration sensor 22, and carries out timing detection according to which the data transmission is performed by the transmitter 2 of the corresponding wheels 5a-5d, namely transmission timing detection, in accordance with the detection signal, and carries out the vehicle speed detection. Moreover, when the frame is produced, the microcomputer 23 carries out frame transmission (data transmission) toward the TPMS-ECU 3 from the transmission antenna 25 through the transmission circuit 24, in accordance with results of the transmission timing detection of the transmitter 2 and the vehicle speed detection.

Specifically, the microcomputer 23 carries out the frame transmission repeatedly at the transmission timing detected by the transmission timing detection, under a condition that the vehicle 1 is running.

It is determined that the vehicle is running, based on the result of the vehicle speed detection. In other words, the vehicle speed detection is carried out in the microcomputer 23 by using the detection signal of the acceleration sensor 22. When the vehicle speed becomes a predetermined speed or greater (for example, 5 km/h), it is determined that the vehicle 1 is running. An output of the acceleration sensor 22 includes an acceleration (a centrifugal acceleration) based on a centrifugal force. By integrating the centrifugal acceleration and multiplying the result by a coefficient, the vehicle speed can be calculated. Therefore, the microcomputer 23 eliminates a gravitational acceleration component from the output of the acceleration sensor 22 and calculates the centrifugal acceleration, thereby to calculate the vehicle speed in accordance with the centrifugal acceleration.

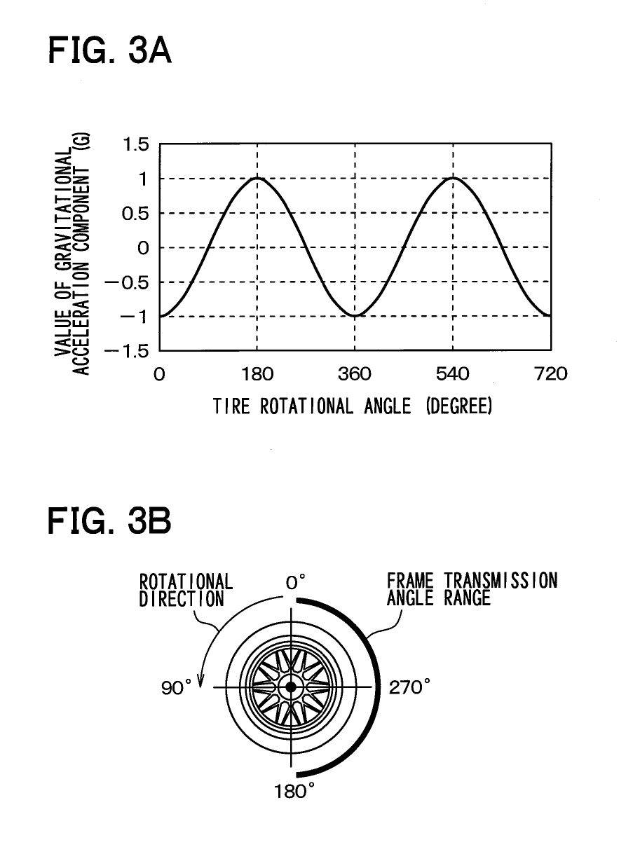

In addition, the transmission timing detection is carried out based on changes of the detection signal of the acceleration sensor 22. In other words, because the detection signals depending on rotation of the corresponding wheels 5a-5d are output by the acceleration sensor 22, the detection signal includes the gravitational acceleration component, which results in a signal having an amplitude depending on wheel rotation, at the time of running. For example, a value of the gravitational acceleration component included in the detection signal of the acceleration sensor 22 oscillates in connection with the tire rotation, as illustrated in FIG. 3A. The amplitude of the oscillation takes the negative maximum amplitude when the acceleration sensor 22 is located in an upper position, zero when the acceleration sensor 22 is located in a horizontal position, and the positive maximum amplitude when the acceleration sensor 22 is located in a lower position, centering a central axis of the wheels 5a-5d.

The transmission timing detection is carried out based on this amplitude, and the transmission timing is set as a timing when values of the gravitational acceleration components are continuously decreased. For example, an angle of the acceleration sensor 22 during one rotation of the tire can be perceived as an angle from zero degree, which is defined when the acceleration sensor 22 is located in the upper position, centering the central axis of each of the wheels 5a-5d. For example, as illustrated in FIG. 3B, when an angle is set in conformity to a rotational direction of the tire, the amplitude becomes the negative maximum when the acceleration sensor 22 is at zero degree, zero when at 90 degrees, the positive maximum when at 180 degrees, and the negative maximum when at 270 degrees. Therefore, the angle of the acceleration sensor 22 can be perceived based on the amplitude of the acceleration sensor 22.

The angle of the acceleration sensor 22 can be easily detected when the acceleration detection is carried out keeping the power supply for the acceleration sensor 220N during one cycle corresponding to one rotation of the tire. However, this leads to increase of the power consumption, and thus the battery life is influenced. Therefore, in the present embodiment, the power consumption is suppressed by carrying out the acceleration detection by the acceleration sensor 22 intermittently at predetermined intervals. In addition, without accurately detecting the angle of the acceleration sensor 22 at the detection timing, it is determined that the transmitter 2 is located within a predetermined angle range when the values of the gravitational acceleration components included in the acceleration at the detection timings are continuously decreased. In other words, when the values of the gravitational acceleration components are continuously decreased, it is assumed that the angle of the acceleration sensor 22 is substantially included in a range of 180 degrees through 360 degrees. Therefore, when the transmission timing is set in a case where the values of the gravitational acceleration components are continuously decreased, the transmission timing can be set so that the acceleration sensor 22 is included in the predetermined angular range, even if the angle of the acceleration sensor 22 is not accurately detected.

When the transmission timing arrives after the vehicle speed reaches a predetermined speed, the timing being set as an initiating timing, the frame transmission from each of the transmitters 2 is carried out. Moreover, when the transmission timings arrive again based on the transmission timing detection, the frame transmission is repeatedly carried out. Incidentally, the transmission timing may be set every time when the values of the gravitational acceleration components are continuously decreased. However, it is preferable that the frame transmission is carried out, for example, once in a predetermined time period (for example, in 15 seconds), without always carrying out every time, taking the battery life into consideration.

The transmission circuit 24 serves as an output section that transmits the frame, which is sent from the microcomputer 23, toward the TPMS-ECU 3 through the transmission antenna 25. Radio waves, for example, in an RF band is used for the frame transmission.

The transmitter 2 configured in such a manner is attached, for example, to an air inlet valve in each of the wheels 5a-5d so that the sensing section 21 is exposed toward the inner side of the tire. When the tire air pressure concerned is detected and the vehicle speed exceeds a predetermined speed, as described above, the transmitter 2 repeatedly carries out the frame transmission through the transmission antenna 25 provided in the transmitter 2 in accordance with the result of the transmission timing detection. The frame transmission may be carried out from the transmitter 2 at a predetermined transmission timing in accordance with the result of the transmission timing detection, consecutively. However, because transmission intervals are preferably longer when the battery life is taken into consideration, it is preferable that a wheel position detection mode is switched to a periodical transmission mode after a time period or the number of transmissions, which is assumed to be necessary for the wheel position detection, elapses. In such a manner, the frame transmission is carried out for every longer constant cycle (for example, for every 1 minute), so that a signal regarding the tire air pressure is periodically transmitted to the TPMS-ECU 3. Here, by providing, for example, a random delay time for each of the transmitters 2, the transmission timings of each of the transmitters 2 may become different, which can prevent the TPMS-ECU 3 from failing in the reception, the failure being caused from interference of the radio waves from the plurality of the transmitters 2.

In addition, the TPMS-ECU 3 is configured to have a reception antenna 31, a reception circuit 32, a microcomputer 33, and the like, as illustrated in FIG. 2B. The TPMS-ECU 3 acquires the gear information from a brake ECU 10 through an in-vehicle LAN such as a CAN, thereby to acquire a gear position indicated by the number of tooth edges (or the number of teeth) of a gear that rotates along with the corresponding wheels 5a-5d, as described later.

The reception antenna 31 receives the frame transmitted from each of the transmitters 2. The reception antenna 31, which is fixed to the vehicle body 6, may be an interior antenna disposed within a body of the TPMS-ECU 3, or an exterior antenna configured by drawing a wiring out from the body.

The reception circuit 32 serves as an input section that inputs the transmission frame, which is transmitted from each of the transmitters 2 and received by the reception antenna 31, and sends the frame to the microcomputer 33. Upon receiving the signal (frame) through the reception antenna 31, the reception circuit 32 conveys the received signal to the microcomputer 33.

The microcomputer 33, which corresponds to a second controlling section, carries out a wheel position detection process in accordance with a program stored in the memory within the microcomputer 33. Specifically, the microcomputer 33 carries out the wheel position detection in accordance with a relationship between the information acquired from the brake ECU 10 and the reception timing at which the transmission frame is received from each of the transmitters 2. From the brake ECU 10, the gear information of wheel speed sensors 11a-11d provided correspondingly in the wheels 5a-5d is acquired at predetermined intervals (for example, 10 milliseconds).

The gear information is information that indicates a gear position of the gear that rotates along with the corresponding one of the wheels 5a-5d. The wheel speed sensors 11a-11d are configured, for example, by electromagnetic pick-up type sensors that are disposed, for example, so as to oppose the gear teeth, and change detection signals with a transit of the gear teeth. Such a type of the wheel speed sensors 11a-11d output a rectangular pulse in response to the teeth transit as a detection signal. Therefore, a rise and a decay of the rectangular pulse represent the transit of the edge of the gear teeth. Accordingly, in the brake ECU 10, the number of tooth edges, or the number of the edge transits of the gear, is counted from the number of the rises and the decays of the detection signals of the vehicle speed sensors 11a-11d, and the number of tooth edges at that time is conveyed as the gear information indicating the teeth position to the microcomputer 33 for every predetermined cycle. Accordingly, the microcomputer 33 can perceive which one of the gear teeth transits at that timing.

The number of tooth edges is reset for every one rotation of the gear. For example, when the number of teeth provided in the gear is forty eight, the number of edges is counted from 0 to 95 at a total of 96. When the counted value reaches 95, the value returns to zero and the counting is started.

Incidentally, while the number of tooth edges of the gear is conveyed as the gear information from the brake ECU 10 to the microcomputer 33, the number of teeth as a counted value of the number of transits of the teeth may be sufficient. In addition, the number of teeth or edges that transit in a predetermined cycle is conveyed to the microcomputer 33, and the number of teeth or edges that transit in the predetermined cycle is added to the previous number of teeth or edges by the microcomputer 33, so that the number of teeth or edges in the cycle may be counted. In other words, it may be sufficient that the number of teeth or edges in the cycle is finally acquired as the gear information by the microcomputer 33. Moreover, while the number of tooth edges (or the number of teeth) of the gear is reset in the brake ECU 10 every time the electric power is off, the measurement is restarted at the same time when the electric power is on, or when a predetermined vehicle speed is reached after the electric power is on. In such a manner, even when the reset is made every time the electric power is off, the same teeth are expressed by the same number of edges (or the number of teeth) when the electric power is on.

The microcomputer 33 measures the reception timing when receiving the frame transmitted from each of the transmitters 2, and carries out the wheel position detection in accordance with the number of tooth edges (or the number of teeth) of the gear at the time of the reception timing of the frame among the number of tooth edges (or the number of teeth) of the gear, which has been acquired. Accordingly, the wheel position detection that specifies to which of the wheels 5a-5d each of the transmitters 2 is attached can be carried out. A specific method of the wheel position detection is explained in detail later.

In addition, the microcomputer 33 stores the ID information of each of the transmitters 2 in association with the positions of the wheels 5a-5d to which the corresponding transmitters 2 are attached, based on the result of the wheel position detection. After that, the microcomputer 33 carries out the tire air pressure detection for the wheels 5a-5d in accordance with the data regarding the tire air pressure and the ID information stored in the transmission frame from each of the transmitters 2, and outputs an electrical signal depending on the tire air pressure to the meter 4 through the in-vehicle LAN such as CAN. For example, the microcomputer 33 detects a reduction of the tire air pressure by comparing the tire air pressure with a predetermined threshold value Th. When the reduction of the tire air pressure is detected, the microcomputer 33 outputs a signal indicating that effect to the meter 4. Accordingly, the fact that the tire air pressure of any one of the four wheels 5a-5d has been reduced is conveyed to the meter 4.

The meter 4, which functions as an alarming section, is disposed in a place visible to a driver, as illustrated in FIG. 1. The meter 4 is configured of a meter display or the like arranged, for example, within an instrument panel in the vehicle 1. The meter 4 notifies the driver of the reduction of the tire air pressure of a specific wheel by displaying the reduction of the tire air pressure, specifying the wheels 5a-5d, when receiving the signal indicating, for example, that the tire air pressure is reduced from the microcomputer 33 in the TPMS-ECU 3.

Subsequently, an operation of a tire air pressure detecting apparatus according to the present embodiment is explained. In the following, although the operation of the tire air pressure detecting apparatus is explained, the tire air pressure detection and the wheel position detection carried out in the tire air pressure detecting apparatus are separately explained.

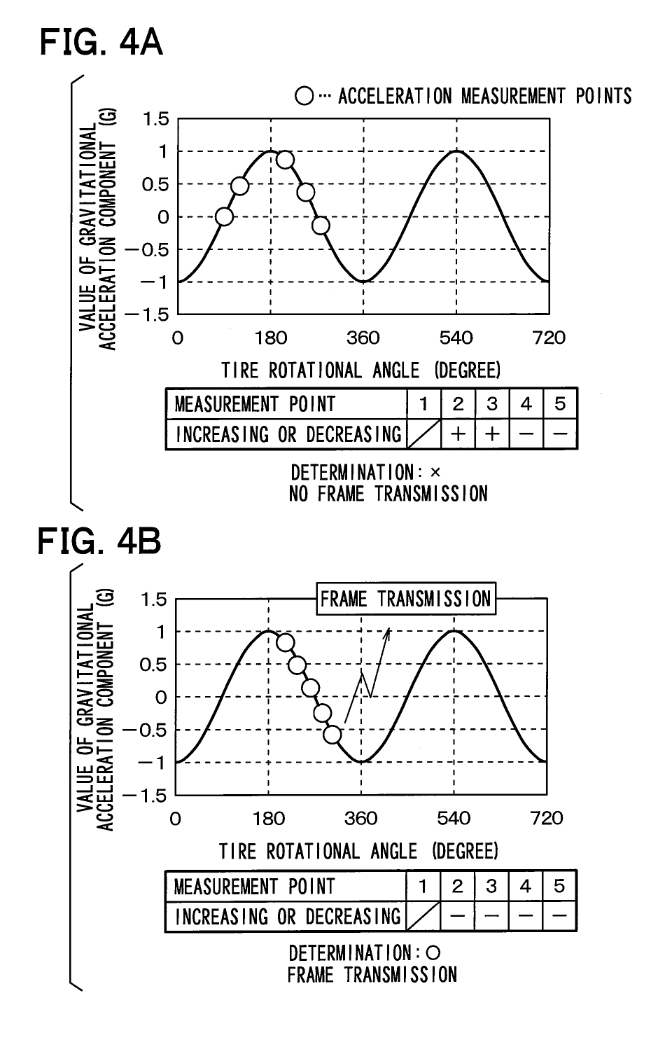

First, the wheel position detection is explained with reference to FIG. 4A through FIG. 13B. In each of the transmitters 2, the microcomputer 23 detects the vehicle speed and the angle of the acceleration sensor 22 of the corresponding one of the wheels 5a-5d by monitoring the acceleration using the acceleration sensors 22 for every predetermined sampling cycle in accordance with the electric power supplied from the battery. When the vehicle speed reaches a predetermined speed, the microcomputer 23 carries out the frame transmission repeatedly at the transmission timings detected by the transmission timing detection. In the present embodiment, a time when the gravitational acceleration components within the detection signals of the acceleration sensor 22 are continuously decreased is set as the transmission timing.

In other words, as illustrated in FIG. 3A and FIG. 3B, the gravitational acceleration component within the detection signal of the acceleration sensor 22 oscillates along with the rotation of the tire. As described above, a case where the gravitational acceleration components within the detection signals of the acceleration sensor 22 are continuously decreased is when the acceleration sensor 22 is positioned in the angle range of 180 degrees through 360 degrees. Therefore, in the present embodiment, the frame transmission from each of the transmitters 2 is carried out when the gravitational acceleration components within the detection signals are continuously decreased, as the transmission timing, without accurately detecting the angle of the acceleration sensor 22.

For example, as illustrated in FIG. 4A and FIG. 4B, the gravitational acceleration component within the detection signal of the acceleration sensor 22 at a measurement point of the acceleration for every sampling cycle is stored. Then, it is determined whether the stored values at measurement points are increased or decreased when compared with a value obtained at the preceding measurement point. Here, when increases and decreases are mixed in the predetermined number of times, for example, in five times of measurements, as illustrated in FIG. 4A, it is determined that the gravitational acceleration components are not continuously decreased, so that no frame transmission is carried out. When only decreases are present as illustrated in FIG. 4B, it is determined that the gravitational acceleration components are continuously decreased, so that the frame transmission is carried out.

After that, the above determining process is continued, and when the gravitational acceleration components within the detection signals of the acceleration sensor 22 are continuously decreased again, the frame transmission is carried out repeatedly at this moment as the transmission timing.

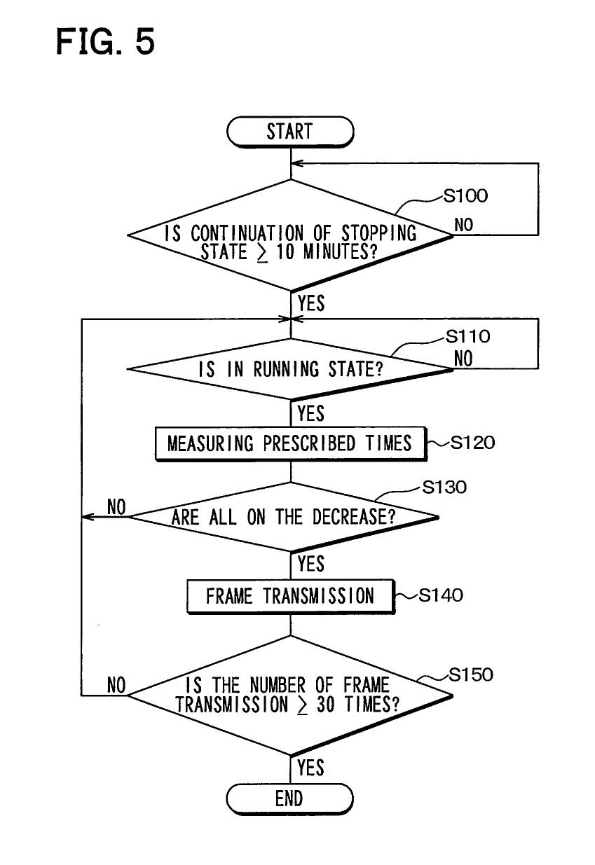

Specifically, each of the transmitters 2 carries out various processes in accordance with a flowchart of a data transmission process for the wheel position detection illustrated in FIG. 5, so that the frame transmission is carried out at the above timing. Incidentally, because each of the transmitters 2 is separated from the vehicle body 6, the data transmission process illustrated in FIG. 5 is carried out for every predetermined controlled cycle, regardless of whether an ignition switch (IG) is on or off.

First, it is determined at S100 whether a stopping state duration is 10 minutes or longer. When a stopping state lasts for a long time, there is a possibility that wheel exchanges such as a tire rotation is carried out. Therefore, only when the stopping state is maintained longer than a certain time, in which the tire exchanges may be carried out, the following processes are carried out.

Next, it is determined at S110 whether or not the vehicle 1 is in a running state. Because the wheels 5a-5d do not rotate during stopping, the wheel position detection cannot be carried out. Therefore, it is determined at this step whether or not the vehicle 1 is in a running state, and only when the vehicle 1 is in a running state, the following processes are carried out.

Subsequently at S120, the acceleration measurement by the acceleration sensor 22 is carried out a prescribed number of times at predetermined measurement intervals. The prescribed number of times may be arbitrarily set. Here, the measurement is carried out five times. When the measurement of the acceleration is completed five times, an advance is made to S130, where it is determined whether or not the gravitational acceleration components indicated by the corresponding data are on the decrease. When determined negative, because the transmission timing has not come, a return is made to S110, where the above process is repeated for retry. In addition, when determined positive, because the transmission timing has come, an advance is made to S140, where the frame transmission is carried out.

Next, an advance is made to S150, where it is determined whether or not the number of the frame transmissions reaches the predetermined number of times (for example, 30 times). Until the number of the frame transmission reaches the predetermined number of times, a return is made to S110 and thus the above process is repeated. When the number of the frame transmission reaches the predetermined number of times, it is assumed that the wheel position detection has been completed in the TPMS-ECU 3. Therefore, the process is completed. In such a manner, the transmission timing detection is carried out, and the frame transmission is carried out repeatedly at the detected transmission timing.

On the other hand, in the TPMS-ECU 3, the gear information of the wheel speed sensors 11a-11d provided in the corresponding wheels 5a-5d is acquired at a predetermined cycle (for example, 10 milliseconds) from the brake ECU 10. Upon receiving the frame transmitted from each of the transmitters 2, the TPMS-ECU 3 measures the reception timing, and acquires the number of edges (or the number of teeth) of the gear at the time of the reception timing of the frame among the acquired number of edges (or the number of teeth) of the gear.

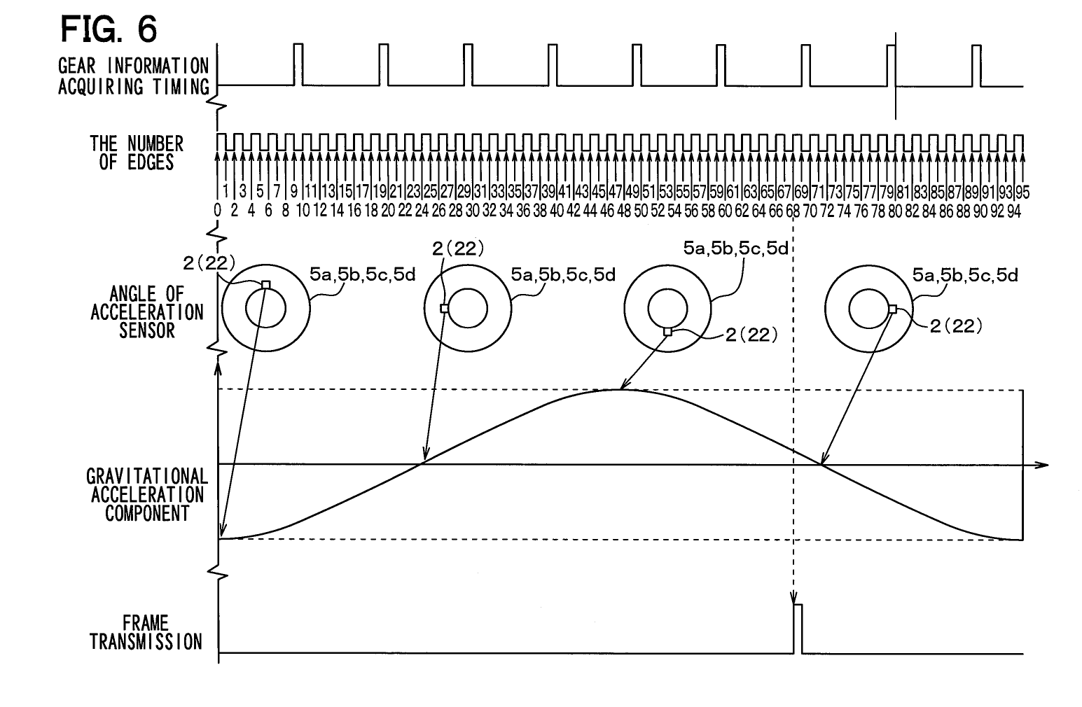

In other words, as illustrated in FIG. 6, the angle formed by the acceleration sensor 22 changes along with the rotation of each of the wheels 5a-5d, so that a value of the gravitational acceleration component of the detection signal of the acceleration sensor 22 changes. Because the value changes occur along with the rotation of the wheels 5a-5d, the number of edges (or the number of teeth) of the gear indicated by the gear information also changes along with the rotation. In a case of the present embodiment, the frame transmission is carried out from the transmitter 2 at a time when the values of the gravitational acceleration components are continuously decreased, as the transmission timing. Therefore, a time when the angle of the acceleration sensor 22 is included in a range of about 180 degrees through 360 degrees is set as the transmission timing, although the angle of the acceleration sensor 22 is not comprehended, and the number of edges (or the number of teeth) of the gear takes a value corresponding to the angle range.

At this time, the transmission timing of the frame transmitted from each of the transmitters 2 does not always correspond to a cycle during which the gear information is acquired from the brake ECU 10. Therefore, the number of edges (or the number of teeth) of the gear indicated by the gear information acquired in a cycle nearest to the reception timing of the frame, or in a cycle immediately before or immediately after the reception timing of the frame, among the cycles during which the gear information is acquired from the brake ECU 10, is used as the number of edges (or the number of teeth) of the gear at the frame reception timing. In addition, by using the number of edges (or teeth) of the gear, which is indicated by the gear information and acquired at the timing immediately before or immediately after the reception timing of the frame, among the cycles during which the gear information is acquired from the brake ECU 10, the number of edges (or the number of teeth) of the gear at the reception timing of the frame may be calculated. For example, a medium value of the number of edges (or the number of teeth) of the gear, which is indicated by the gear information and acquired at the timings immediately before and immediately after the reception timing of the frame may be used as the number of edges (or the number of teeth) of the gear at the reception timing of the frame.

Such an operation of acquiring the number of edges (or the number of teeth) of the gear at the reception timing of the frame is repeated every time the frame is received, and the wheel position detection is carried out based on the acquired number of edges (or the number of teeth) of the gear at the reception timing of the frame. Specifically, the wheel position detection is carried out by determining whether or not variations in the numbers of edges (or the number of teeth) of the gear at the reception timing of the frame received plural times are within an angle range of 180 degrees, namely, variations in the numbers of edges of the gear are within 48 (or variations in the numbers of teeth are within 24).

Regarding the wheel for which the frame is received, because the frame transmission is carried out at the timing at which the acceleration sensor 22 is included in the predetermined angle range, the variations of the teeth positions indicated by the number of edges (or the number of teeth) of the gear at the reception timing of the frame are within the predetermined angle range. Therefore, the variations in the number of edges (or the number of teeth) of the gear at the reception timing of the frame falls within the angle range of 180 degrees. This holds true even when the frame is received plural times. On the other hand, regarding the wheel other than the wheel for which the frame is received, the teeth positions indicated by the number of edges (or the number of teeth) of the gear at the reception timing of the frame transmitted from the transmitter 2 of other wheels may vary.

In other words, because the gears of the vehicle speed sensors 11a-11d rotate in connection with the corresponding wheels 5a-5d, regarding the wheel for which the frame is received, the teeth positions indicated by the number of edges (or the number of teeth) of the gear at the reception timing of the frame fall within the angle range of 180 degrees. However, because rotating states of the wheels 5a-5d may be varied by road conditions, turn or lane changes, or the like, the rotating states of the wheels 5a-5d cannot be completely the same. Therefore, regarding the wheel other than the wheel for which the frame is received, a case may happen in which the teeth positions indicated by the number of edges (or the number of teeth) of the gear at the reception timing of the frame do not fall within the angle range of 180 degrees.

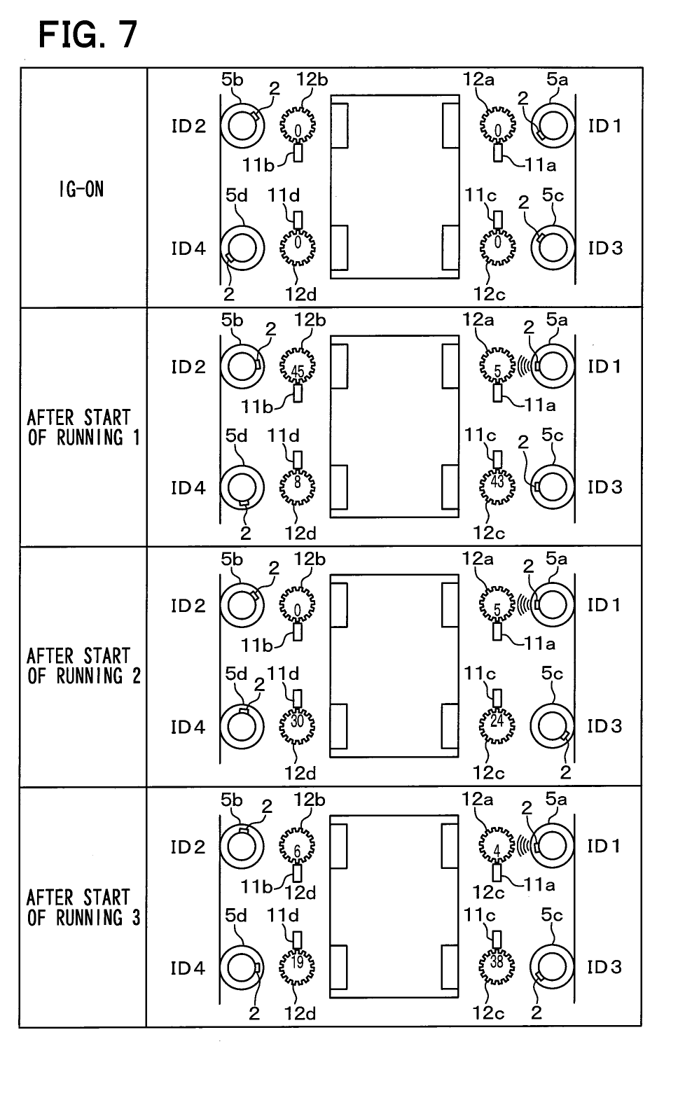

Therefore, as illustrated in FIG. 7, after the IG is on and after the vehicle starts running, regarding the wheels 5b-5d other than the wheel 5a for which the frame is received, the variations of the teeth positions indicated by the number of edges (or the number of teeth) of the gear at the reception timing of the frame become larger. Specifically, the number of edges (or the number of teeth) of the gears 12a-12d becomes zero at the very beginning when the IG is on, and after the vehicle starts running, the teeth positions indicated by the number of edges (or the number of teeth) of the gear at the reception timing of the frame vary. In this case, for example, in the wheel 5a for which the frame is received, the number of gear teeth at the reception timing of the frame is within 180 degrees for all the gears, or within 24. However, in the wheels 5b-5d other than the wheel for which the frame is received, the number of teeth may be out of the range of 180 degrees. Based on this, the wheel position detection is carried out.

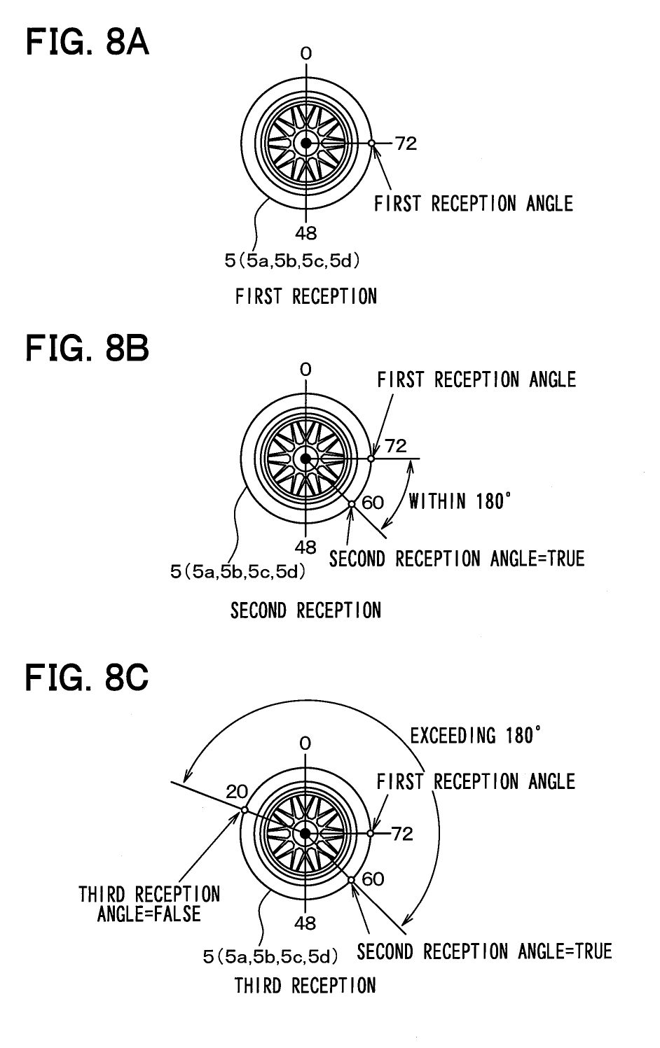

For example, as illustrated in FIG. 8A, regarding each of the wheels 5a-5d, it is presumed that the position of the transmitter 2 indicated by the number of edges (or the number of teeth) of the gears at the time of transmitting the first frame is a first reception angle (the number of edges=72). Then, as illustrated in FIG. 8B, it is determined whether the first reception angle and a second reception angle (the number of edges=60), which is a position of the transmitter 2 and indicated by the number of edges (or the number of teeth) of the gear at the time of a second frame reception, are included in the range of 180 degrees. When included in the range, there is a possibility that the wheel corresponds to the wheel for which the frame transmission is carried out, which leads to TRUE (correct).

Next, as illustrated in FIG. 8C, a third reception angle (the number of edges=12), which is a position of the transmitter 2 and indicated by the number of edges (or the number of teeth) of the gear at the time of a third frame reception, is obtained. Then, it is determined whether all the first through the third reception angles are included in the range of 180 degrees. In other words, it is determined whether all the reception angles at all receptions, rather than an angle from the first reception angle (the number of edges=72), which is an initial value, are included in the range of 180 degrees. At this time, when included in the range, there is a possibility that the wheel corresponds to the wheel for which the frame transmission is carried out, which leads to TRUE. However, as illustrated in the drawing, when not included in the range, the wheel does not correspond to the wheel for which the frame transmission is carried out, which ends in FALSE. In such a manner, it becomes possible to specify which of the wheels 5a-5d to which the transmitter 2 that has transmitted the received frame is attached.

Regarding the wheels different from the wheel for which the frame transmission is carried out, the reception angles are out of the range of 180 degrees with a probability of ½, which ends in FALSE. Therefore, when the determining as above is carried out ten times, the reception angles are included in the range of 180 degrees with a probability of 100% in the case of the wheel for which the frame transmission is carried out. However, regarding the wheel different from that, a probability for the reception angles to be included in the range of 180 degrees is 1/210×100% and thus substantially 0%. Therefore, by carrying out the above determining, the wheel position detection can be carried out certainly.

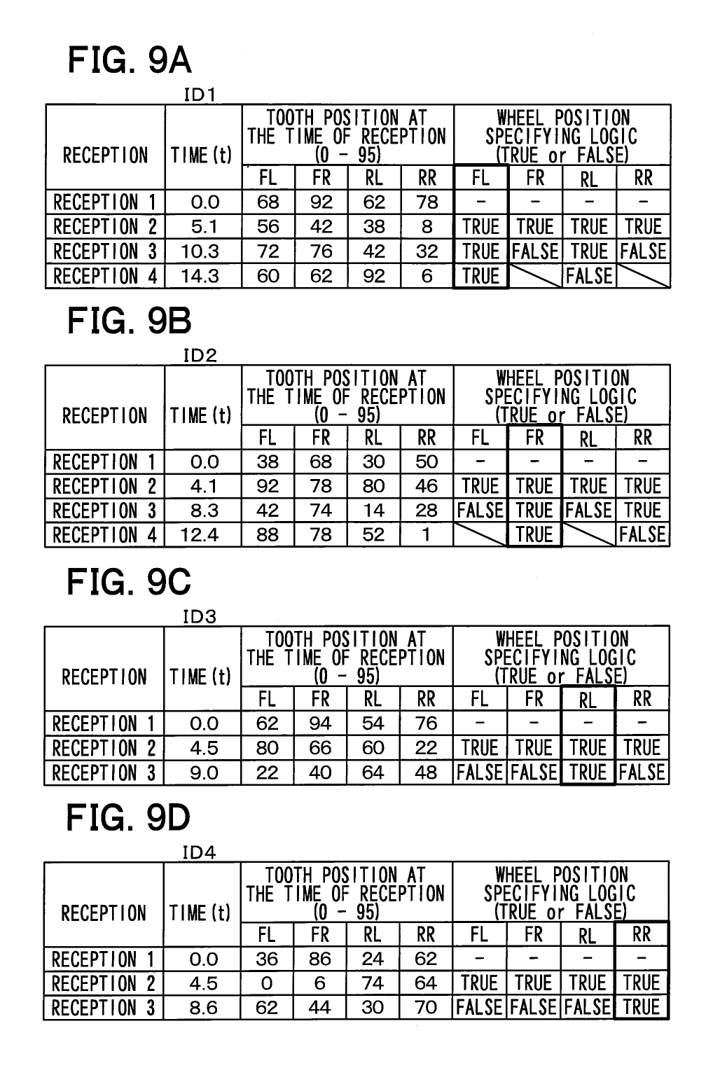

Specifically, as illustrated in FIG. 9A, regarding the frame in which 101 is included as the identification information, the number of edges (or teeth) of the gear is acquired for every reception timing of the frame, and the number of edges (or the number of teeth) of the gear is stored for every one of the wheels (a front left wheel FL, a front right wheel FR, a rear left wheel RL, a rear right wheel RR). Every time when the frame is received, it is determined whether the acquired number of edges (or the number of teeth) of the gear is included in the range of the number of edges (or the number of teeth) by 180 degrees of the gear. The wheel for which determined out of the range is eliminated from candidates of the wheel to which the transmitter 2 that has transmitted the frame is attached. The wheel that finally remains not eliminated is registered as the wheel to which the transmitter 2 that has transmitted the frame is attached. In the case of the frame including the ID1, the front right wheel FR, the rear right wheel RR, and the rear left wheel RL are eliminated in sequence from the candidates, and the front left wheel FL that finally remains is registered as the wheel to which the transmitter 2 that has transmitted the frame is attached.

As illustrated in FIG. 9B through FIG. 9D, the same process as the frame including ID1 is carried out for the frames in which ID2 through ID4 are included as the identification information. Accordingly, the wheels to which the transmitters 2 that have transmitted the corresponding frames are attached can be specified, so that it becomes possible to specify all the four wheels to which the corresponding transmitters 2 that have transmitted the frames are attached.

In such a manner, which of the wheels 5a-5d from which the corresponding frames are transmitted is specified. Then, the microcomputer 33 stores the ID information of each of the transmitters 2 that have transmitted the frames in association with the position of the wheel to which the transmitter 2 is attached.

When the wheel position detection is carried out in such a manner, then the tire air pressure detection is carried out. Specifically, in the case of the tire air pressure detection, the frame is transmitted for every constant cycle from each of the transmitters 2, and every time the frame is transmitted from each of the transmitters 2, the frame corresponding to the four wheels are received by the TPMS-ECU 3. Then, the TPMS-ECU 3 specifies from which of the transmitters 2 attached in the corresponding wheels 5a-5d the frames are transmitted, in accordance with the ID information stored in each of the frames. Then, the tire air pressure of each of the wheels 5a-5d is detected from the information regarding the tire air pressure. Accordingly, a reduced tire air pressure in each of the wheels 5a-5d can be detected, and thus it becomes possible to specify in which of the wheels 5a-5d the tire air pressure is reduced. When a reduced tire air pressure is detected, the fact is conveyed to the meter 4, so that display indicating the reduced tire air pressure while specifying the wheels 5a-5d is made by the meter 4, thereby to notify the driver of the reduced tire air pressure in a specified wheel.

As explained in the foregoing, the gear information that indicates the teeth position of the gears 12a-12d is acquired based on the detection signals of the wheel speed sensors 11a-11d, and the wheel position detection is carried out based on the gear information at the reception timing of the frame. With such a method, when the wheel position detection is carried out, the frame transmission is carried out when the values of the gravitational acceleration components included in the detection signals of the acceleration sensor 22 at the detection timings are continuously decreased. In other words, without directly detecting the angle of the acceleration sensor 22 provided in the transmitter 2, the transmission timing is detected based on only an increasing or decreasing direction of values of the gravitational acceleration components included in the detection signals of the acceleration sensor 22, and the frame transmission is carried out.

Therefore, the frame transmission can be certainly carried out when the acceleration sensor 22 is included in a predetermined angle range, even when the acceleration detection by the acceleration sensor 22 is carried out at predetermined intervals, rather than constantly. Accordingly, the frame transmission can be carried out at appropriate timings, without carrying out the acceleration detection while the electric power of the acceleration sensor 22 is kept on during one cycle corresponding to one rotation of the tire. Therefore, the wheel position detection is correctly carried out, and power consumption can be suppressed.

### Second Embodiment

A second embodiment of the present invention is explained. In the present embodiment, the intervals of the acceleration detection by the acceleration sensor 22 is variable, in contrast to the first embodiment, and others are substantially the same as those in the first embodiment. Only the different parts from the first embodiment are explained.

As explained in the above first embodiment, the wheel position detection can be carried out by carrying out the frame transmission when the values of the gravitational acceleration components included in the detection signals of the acceleration sensor 22 are continuously decreased, assuming that the acceleration sensor 22 is included in the predetermined angle range. However, because a cycle of vibrational amplitude of the gravitational acceleration component corresponds to the rotational cycle of each of the wheels 5a-5d, as the vehicle speed becomes greater, the cycle of the vibrational amplitude of the gravitational acceleration component becomes shorter. This may cause a case where the sufficient number of the acceleration detections in one oscillation cannot be carried out, depending on the vehicle speed.

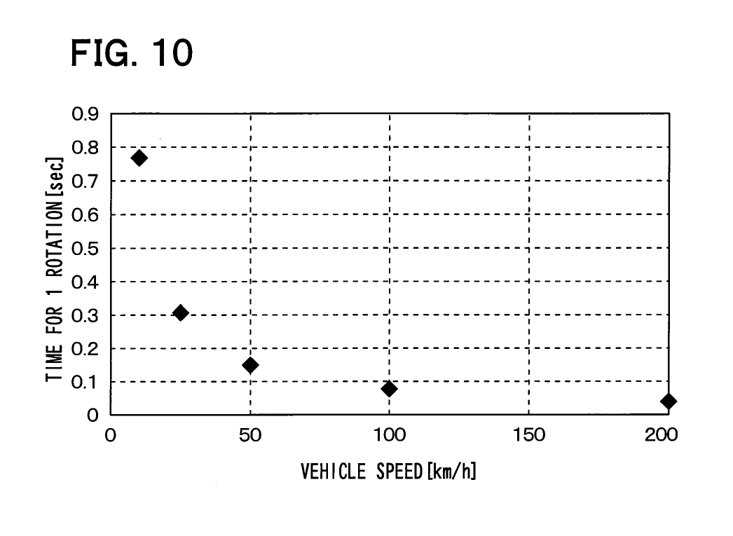

For example, as illustrated in FIG. 10, a time required for the wheels 5a-5d to rotate one rotation changes depending on the vehicle speed. For example, when a tire size is 245/R45 18 and the vehicle speed exceeds 100 km/h, the time required for one rotation is 1 second or shorter. Although a situation where the vehicle speed rapidly becomes 100 km/h from a vehicle stopping state is not very perceived normally, there is a possibility that the wheel position detection cannot be accurately carried out in such a case. When the measurement intervals are set depending on the vehicle speed, so that the measurement intervals are shorter as the vehicle speed becomes faster, the measurement intervals can be sufficiently shorter than the vibrational cycle of the gravitational acceleration component, which allows a situation where the gravitational acceleration components are continuously decreased to be accurately detected.

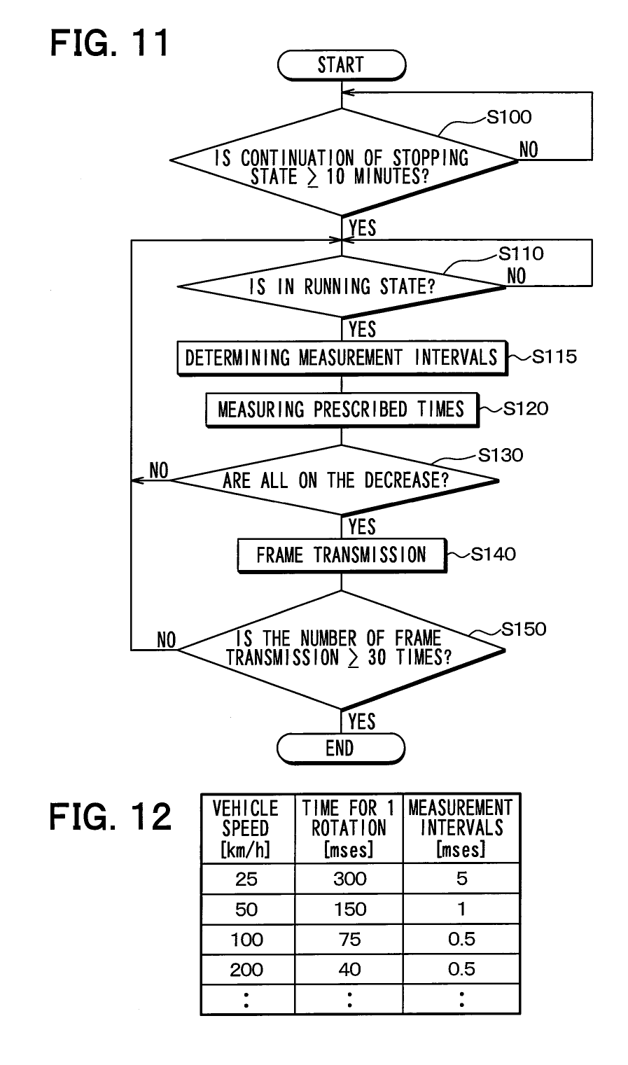

Specifically, in the present embodiment, each of the transmitters 2 carries out a data transmission process for the wheel position detection illustrated in the flowchart of FIG. 11. Incidentally, this data transmission process is basically substantially the same as the data transmission process explained in the first embodiment, but a process illustrated in S115 is added.

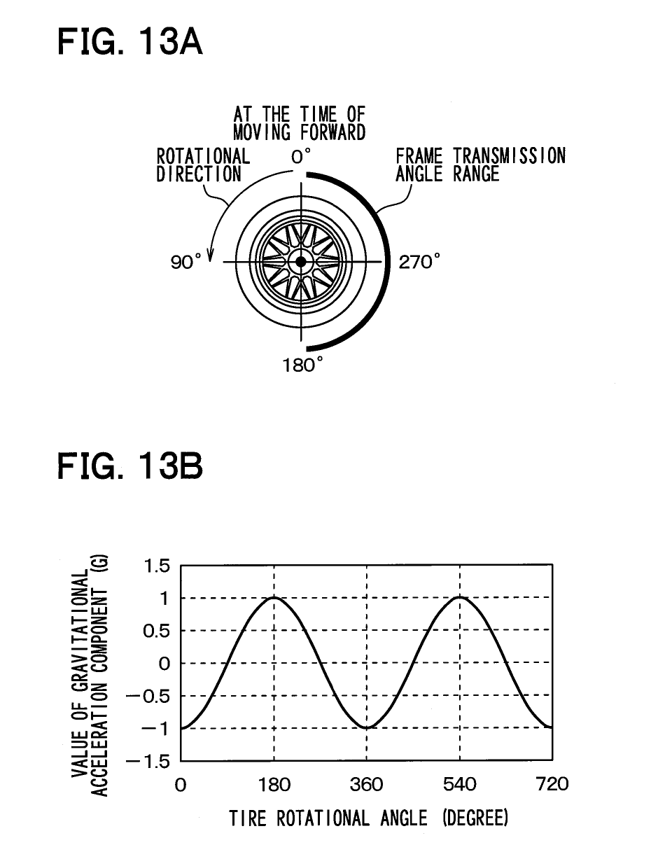

First, at S100 through S110, the processes of S100 through S110 of FIG. 5 explained in the first embodiment are carried out. Then, the measurement intervals for the acceleration sensor 22 are determined at S115. Specifically, the measurement intervals are set based on the vehicle speed, so that as the vehicle speed is increased the measurement intervals become shorter. For example, as illustrated in FIG. 12, because a time required for the wheels 5a-5d to rotate one rotation varies, the measurement intervals are shorter accordingly. Specifically, when the vehicle speed is 25 km/h, because the time required for one rotation becomes 300 milliseconds, the measurement intervals are set to be 5 milliseconds. When the vehicle speed is 50 km/h, because the time required for one rotation becomes 150 milliseconds, the measurement intervals are set to be 1 milliseconds. In addition, when the vehicle speed is 100 km/h or greater, the measurement intervals are set to be 0.5 milliseconds. Regarding the vehicle speed, because the vehicle speed detection is carried out based on the detection signal of the acceleration sensor 22, the result is used.

When the measurement intervals are determined in such a manner, the acceleration measurement by the acceleration sensor 22 is carried out at S120 at the measurement intervals determined at S115 prescribed times. After that, by carrying out the processes of S130 and beyond in FIG. 5 that have been explained in the first embodiment, the frame transmission can be carried out when the values of the gravitational acceleration components included in the detection signals of the acceleration sensor 22 are continuously decreased.

As explained in the foregoing, the measurement intervals for the acceleration sensor 22 are determined depending on the vehicle speed. Accordingly, even when the vehicle speed is increased and thus the oscillation cycle of the gravitational acceleration component becomes shorter, the acceleration detection can be carried out sufficient times in one cycle of oscillation. Accordingly, even when the vehicle speed becomes higher, the transmitter 2 can carry out the frame transmission at appropriate timings, thereby to certainly carry out the wheel position detection.

### Third Embodiment

A third embodiment of the present invention is explained. In the present embodiment, the wheel position detection with the times of moving forward and backward of the vehicle 1 taken into consideration is carried out, in contrast to the first embodiment, and others are substantially the same as those in the first embodiment. Only the different parts from the first embodiment are explained.

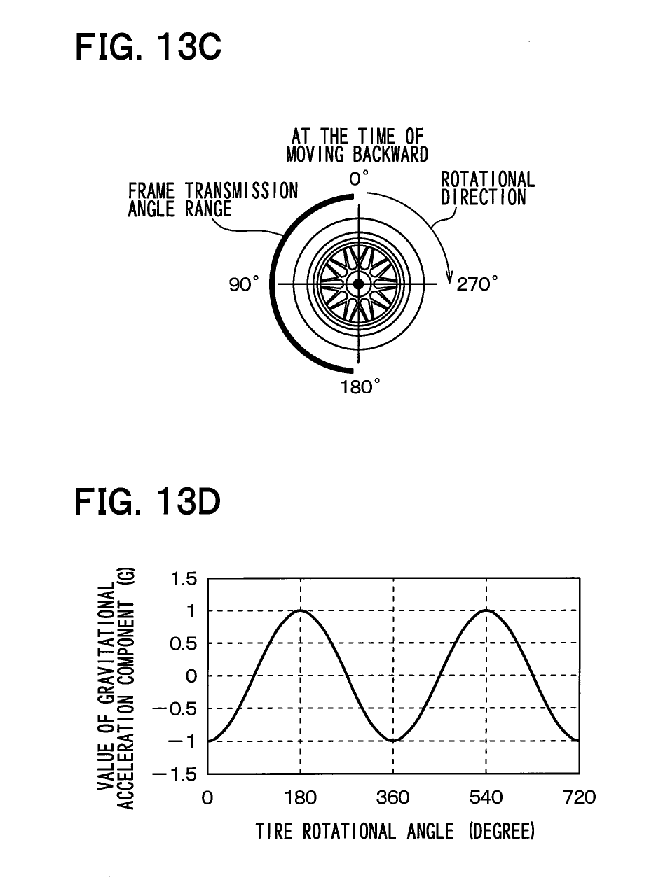

As illustrated in FIG. 13A through FIG. 13D, the angle made by the acceleration sensor 22 when the values of the gravitational acceleration components included in the detection signals of the acceleration sensor 22 are on the decrease becomes opposite by 180 degrees between at the time of moving forward and at the time of moving backward of the vehicle 1, because the tire rotating directions are opposite. Therefore, the TPMS-ECU 3 acquires information regarding a moving direction of the vehicle 1. When the moving direction of the vehicle 1 is, for example, backward, even if the frame is received, the wheel position detection in accordance with the gear information at the time is not carried out; and when the moving direction of the vehicle 1 is forward, the wheel position detection is carried out using only the gear information when the frame is received.

In such a manner, the wheel position detection corresponding to the moving direction of the vehicle 1 can be carried out, thereby to enable more accurate wheel position detection. Incidentally, regarding the information on the moving direction of the vehicle 1, shift position information can be acquired from, for example, a transmission ECU or the like. In addition, depending on a type of the wheel speed sensors 11a-11d, it can be confirmed whether the rotation direction of the gear is either the forward direction or the backward direction of the vehicle 1. Therefore, the information on the moving direction of the vehicle 1 can be received from the brake ECU 10, in addition to the gear information.

In addition, because the vehicle speed at the time of moving backward is generally low, the frame transmission may be carried out only when the vehicle speed reaches to such a degree that cannot be conceived at the time of moving backward, for example, 20 km/h or greater. In such a manner, the frame can be received by the TPMS-ECU 3 at the time of moving forward. Therefore, the wheel position detection corresponding to the moving direction of the vehicle 1 can be carried out.

### Other Embodiments

Although a time when the values of the gravitational acceleration components included in the detection signals of the acceleration sensor 22 are continuously decreased is set as the frame transmission timing in each of the above embodiments, a time when the value is continuously increased may be set as the transmission timing. In other words, a time when an increasing or decreasing direction of values of the gravitational acceleration components is continuously the same direction can be set as the frame transmission timing. However, because an influence of the centrifugal force component included in the detection signal of the acceleration sensor 22 becomes larger during rapid acceleration or rapid deceleration, it becomes difficult to accurately extract a value of the gravitational acceleration component. Taking this point into consideration, a time when the values of the gravitational acceleration components included in the detection signals of the acceleration sensor 22 are continuously decreased is preferably set as the frame transmission timing, because the rapid acceleration takes place more frequently than the rapid deceleration.

In order to prevent errors of the frame transmission due to acceleration and deceleration from occurring, it is preferable to detect a speed difference of the acceleration between at the start of the measurement and at the end of the measurement when detecting the transmission timing by the acceleration sensor 22 and to determine whether the frame transmission is accepted or rejected based on the speed difference. In other words, a measurement time of the acceleration when the detection of the transmission timing is started is assumed as a time point of the start of the measurement; and a measurement time of the acceleration when the detection of the transmission timing is ended is assumed as a time point of the end of the measurement. Then, it is determined whether or not the speed difference of the acceleration between those time points exceeds a threshold value. When it is determined that the speed difference does not exceed the threshold value, the frame transmission is carried out; and when it is determined that the speed difference exceeds the threshold value, the frame transmission is not carried out. Accordingly, the frame transmission can be prevented from being carried out when the influence of the centrifugal force component is larger, thereby to enable the wheel position detection more accurately.

While the transmitter 2 carries out the data transmission process and then carries out the frame transmission, when the frame transmission condition is not satisfied at S130 of FIG. 5 and FIG. 11, a return is made to S110, where the above process is retried, and the measurement of the acceleration is carried out predetermined number of times. However, depending on the vehicle speed, an oscillation cycle of the gravitational acceleration component included in the detection signal of the acceleration sensor 22 and a retry cycle are synchronized, which may cause the acceleration measurement to be carried out every time values of the gravitational acceleration components are on the increase. In this case, because there may be a possibility where the frame transmission condition is not satisfied for a long time, it is preferable that a timing of the retry is randomly changed when the retry is carried out.

In the above embodiments, the TPMS-ECU 3 acquires the gear information from the brake ECU 10. However, because it is sufficient if the TPMS-ECU 3 can acquire the number of tooth edges or the number of teeth of the gear as the gear information, the number of tooth edges or the number of teeth of the gear may be acquired from other ECUs. Otherwise, the detection signals of the wheel speed sensors 11a-11d are input, and thus the number of tooth edges or the number of teeth of the gear may be acquired from the detection signals. Especially, although a case where the TPMS-ECU 3 and the brake ECU 10 are configured as separate ECUs is explained in the above embodiments, these may be integrated into a single ECU. In this case, this ECU directly inputs the detection signals of the wheel speed sensors 11a-11d and acquires the number of tooth edges or the number of teeth of the gear from the detection signals. In addition, in this case, because the number of tooth edges or the number of teeth of the gear can be constantly acquired, the wheel position detection can be carried out based on the gear information exactly at the frame reception timing, which is different from a case where the information is acquired at predetermined intervals.

Although an explanation has been made about the wheel position detection apparatus provided in the vehicle 1 provided with the four wheels 5a-5d in the above embodiments, the present invention is applicable in substantially the same manner to a vehicle with the larger number of wheels.

Incidentally, it is sufficient if the transits of the teeth of the gear that rotates in connection with the rotation of the wheels 5a-5d can be detected by the wheel speed sensors 11a-11d. Therefore, the gear may have a structure where tooth portions whose circumferential surfaces are electrically conductive and portions positioned between the teeth are alternatively repeated with each other so that magnetic resistances are different. In other words, not only a generic gear configured of convex portions whose circumferential surfaces are electrically conductive and spaces that are not electrically conductive, by making the outer peripheral portion thereof be in the form of convex-concave, but also, for example, a rotary switch or the like whose circumferential surface is configured of a portion that is electrically conductive and another portion that is electrically insulating is included (see, JP-H10-048233-A).

What is claimed is:

1. A wheel position detecting device applied to a vehicle in which a plurality of wheels provided with tires are attached to a vehicle body, the wheel position detecting device comprising:
transmitters, each of which is provided in a corresponding one of the plurality of the wheels, and has a first controlling section that produces and transmits a frame including specific identification information; and
a receiver that is provided in the vehicle body and has a second controlling section, the second controlling section receiving the frame transmitted from the transmitters through a reception antenna to specify in which wheels the transmitters that have transmitted the frame are provided, and carrying out wheel position detection by which the plurality of the wheels and the identification information of the transmitters provided in the plurality of the wheels are stored in association with each other, wherein
each of the transmitters includes an acceleration sensor that measures acceleration including a gravitational acceleration component that varies in connection with rotation of the wheels in which the corresponding transmitters are provided at predetermined intervals, and outputs a detection signal depending on the acceleration,
the first controlling section detects transmission timing in accordance with a value of the gravitational acceleration component included in the detection signal of the acceleration sensor, which is detected at predetermined intervals, and repeatedly transmits the frame when an establishing condition is met, wherein the establishing condition of the transmission timing is that an increasing or decreasing direction of values of the gravitational acceleration components are continuously the same direction,
the second controlling section acquires gear information indicating a tooth position of gears in accordance with a detection signal of wheel speed sensors that outputs the detection signal depending on transits of teeth of the gears that are rotated in connection with the plurality of the wheels, and specifies the wheels in which the transmitters that have transmitted the frame are provided, in accordance with whether the teeth position is included in a range of 180 degrees of the gears at the reception timing of the frame.

2. The wheel position detecting device according to claim 1, wherein
the first controlling section sets the transmission timing as a time when values of the gravitational acceleration components included in the detection signals detected at the predetermined intervals are continuously on the decrease.

3. The wheel position detecting device according to claim 2, wherein
the first controlling section sets the transmission timing as a time when the values of the gravitational acceleration components included in the detection signals detected at the predetermined intervals are decreased continually predetermined number of times.

4. The wheel position detecting device according to claim 1, wherein
the first controlling section performs a vehicle speed detection in accordance with the detection signal of the acceleration sensor, and determines whether or not the increasing or decreasing direction of the values of the gravitational acceleration components are continuously the same direction, in accordance with a result of the vehicle speed detection after the vehicle speed reaches a predetermined speed.

5. The wheel position detecting device according to claim 1, wherein
the first controlling section performs a vehicle speed detection in accordance with the detection signal of the acceleration sensor, and determines intervals at which the acceleration sensor performs a measurement of acceleration, in accordance with a detected vehicle speed.

6. The wheel position detecting device according to claim 1, wherein
the first controlling section determines whether or not the frame transmission is performed based on a difference between the acceleration at a time of measurement starting time and the acceleration at a time of measurement ending time when the transmission timing is detected, wherein the time of measurement starting time is a time of measuring the acceleration when the transmission timing detection is started, and the time of measurement ending time is a time of measuring the acceleration when the transmission timing detection is ended.

7. The wheel position detecting device according to claim 1, wherein
when the establishing condition is not met, the first controlling section repeatedly tries the acceleration measurement with the acceleration sensor until the establishing condition is met.

8. The wheel position detecting device according to claim 7, wherein
the first controlling section performs the acceleration measurement with the acceleration sensor predetermined number of times,
the establishing condition is set to be met when the increasing or decreasing direction of the values of the gravitational acceleration components is continuously the same direction for the predetermined number of times, and
intervals at which the measurement of the acceleration is performed the predetermined number of times are randomly set when the repeated try is performed.

9. The wheel position detecting device according to claim 1, wherein
the receiver acquires information indicating whether the moving direction of the vehicle is forward direction or backward direction, and performs the wheel position detection only using the gear information when the frame is received at the time of forward direction.

10. A tire air pressure detecting apparatus comprising the wheel position detecting device according to claim 1, wherein
the transmitter includes a sensing section that outputs a detection signal depending on an air pressure of the tire provided to each of the plurality of the wheels, and transmits a frame to the receiver after storing information regarding the air pressure of the tire for which the detection signal from the sensing section is signal-processed by the first controlling section in the frame, and
the receiver detects the air pressure of the tire provided to each of the plurality of the wheels from the information regarding the air pressure of the tire in the second controlling section.
